(19) United States
(12) Patent Application Publication
(10) Pub. No.: US 2009/0300389 A1
(43) Pub. Date: Dec. 3, 2009

(54) POWER SUPPLY HAVING MULTIPLE SETS OF OUTPUT POWER

(75) Inventor: Ching-Ling CHOU, Taipei Hsien (TW)

Correspondence Address: Muncy, Geissler, Olds & Lowe, PLLC, P.O. BOX 1364, FAIRFAX, VA, 22038-1364, US

(73) Assignee: TOPOWER COMPUTER INDUSTRIAL CO., LTD.

(21) Appl. No.: 12/129,176

(22) Filed: May 29, 2008

(51) Int. Cl. G06F 1/32

(52) U.S. Cl. 713/323

(57) ABSTRACT

A power supply having multiple sets of output power includes a primary power system to transform AC power to DC power when a computer host is power on and a standby power system linking and transforming the AC power to the DC power when the computer host is shut down. The power supply has a power output port located outside. The power output port has a primary power terminal dock linking to the primary power system and a standby power terminal dock linking to the standby power system. A transmission line is provided that has one end electrically connected to the power output port and other end forming at least a first coupling end and a second coupling end to output respectively primary power and standby power to a linking and corresponding computer equipment and an external electronic device. Thus the power supply can provide electric power to the computer equipment and external electronic device through the transmission line when the computer host is power on, and continuously provide the electric power to the external electronic device when the machine is shut down. It solves the problem of the conventional power supply that can provide power only when the machine is power on.

### FIELD OF THE INVENTION

The present invention relates to a power supply that has multiple sets of output power and particularly to a power supply that can output a standby power to external electronic devices even in a shutdown condition.

### BACKGROUND OF THE INVENTION

Continuous advance of technology has spawned a wide variety of electronic products such as handsets, MP3 players, digital cameras, GPS (Global Positioning System), video games and consoles and the like. In the past, when electric power is inadequate or exhausted on those electronic products, batteries have to be replaced or charged through chargers. As the chargers of electronic products made by different producers have different specifications, users have to procure many different types of chargers to mate with the electronic products, and a specific charger has to be selected for a specific product when it is in use. It is troublesome. Moreover, it often happens that the old charger does not fit a newly procured electronic product. This is not economically justified and also creates a big environmental concern.

To remedy the aforesaid problem, some techniques have been developed to provide a transmission line of a single specification to connect an electronic product and a computer host so that different electronic products can get electric power through a common transmission line. For instance, R.O.C. Patent No. M242774 discloses a power supply module located on a computer host to provide power for operation thereof. The power supply has at least one second power supply socket to be linked to supply DC operation power for a computer peripheral equipment. R.O.C. Patent No. 245516 discloses a computer extra power sharing device to share extra power of a power supply of a computer host to other electronic devices. It has a power connector linking to the power supply. The power connector has at least one connection interface exposed outside the computer host to be connected by the electronic devices outside the computer host to share the electric power provided by the power supply. Both M242774 and M245516 mainly provide a power socket to be coupled by external electronic devices to allow the power of the power supply to be transmitted to the external electronic devices. Another R.O.C. Patent No. I249272 provides a signal adapter line which is directly connected to an external electronic device to provide electric power and control a signal source. It includes a power supply located on a computer host. The power supply has a first connection port which contains a power pin and a signal pin. The signal pin is connected to a signal transmission line linking to the computer host. The signal adapter line has one end connecting to an adapter to be coupled with the first connection port and another end equipped with a power coupling dock and a signal coupling dock to be connected to a power port and a signal port of an external electronic device. Thereby the power can be supplied and the signal source of the external electronic device can be controlled.

However, the techniques set forth above can provide electric power to the external electronic device only after the machine is power on. When the machine is shut down the power supply also stops. As a result, the external electronic device can get electric power only during the computer is operating or the computer host has to be started specifically for this purpose. It creates a lot of inconvenience in use.

### SUMMARY OF THE INVENTION

The primary object of the present invention is to solve the aforesaid disadvantages by providing a power supply that can output power even in a shutdown condition to external electronic devices.

The power supply of the invention can provide multiple sets of output power. It has a primary power system to transform AC power to DC power in a power on condition and a standby power system connecting to the AC power in regular conditions to transform the AC power to the DC power. The power supply also has a power output port at one end that has a primary power terminal dock connecting to the primary power system and a standby power terminal dock connecting to the standby power system. A transmission line is provided that has one end forming an adapter end electrically connected to the power output port and other end forming at least a first coupling end and a second coupling end to output respectively primary power and standby power corresponding and linking to a computer equipment and an external electronic device. Therefore when the power supply is power on it can supply the primary power and standby power respectively to the computer equipment and external electronic device through the transmission line. When the power supply is shut down the standby power can continuously be provided to the external electronic device. Thus the external electronic device can receive electric power and operate whether the power supply is power on or shut down.

The power supply thus formed can simplify power supply for the external electronic device and offer a significant improvement over the conventional techniques.

The foregoing, as well as additional objects, features and advantages of the invention will be more readily apparent from the following detailed description, which proceeds with reference to the accompanying drawings.

### BRIEF DESCRIPTION OF THE DRAWINGS

FIGS. 1A and 1B are schematic views of a first embodiment of the invention.

FIG. 2 is a schematic view of a second embodiment of the invention.

FIG. 3 is a schematic view of a third embodiment of the invention.

FIGS. 4A and 4B are schematic views of a fourth embodiment of the invention.

FIGS. 5A and 5B are schematic views of a fifth embodiment of the invention.

### DETAILED DESCRIPTION OF THE PREFERRED EMBODIMENTS

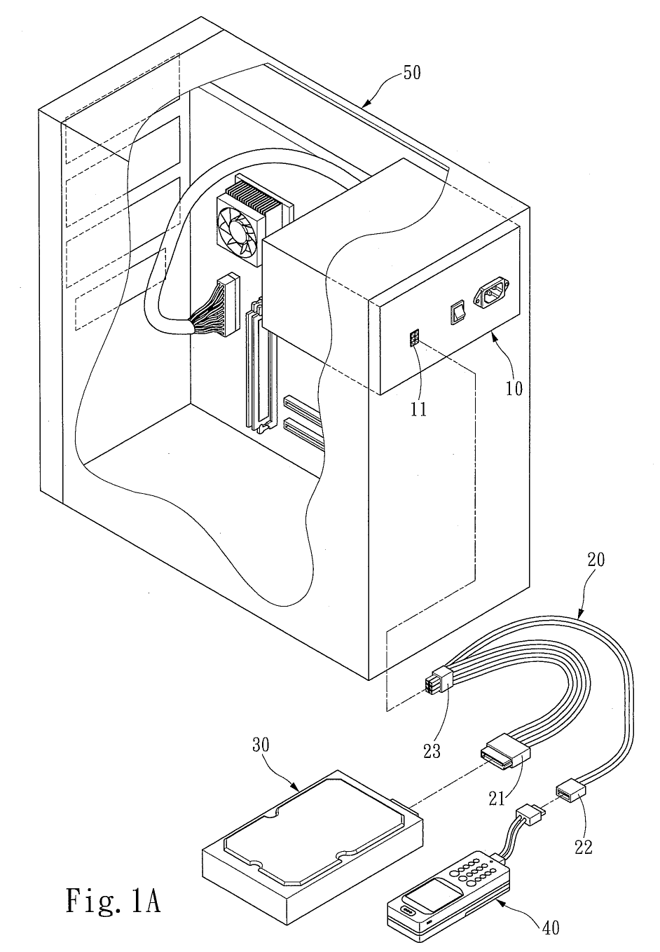

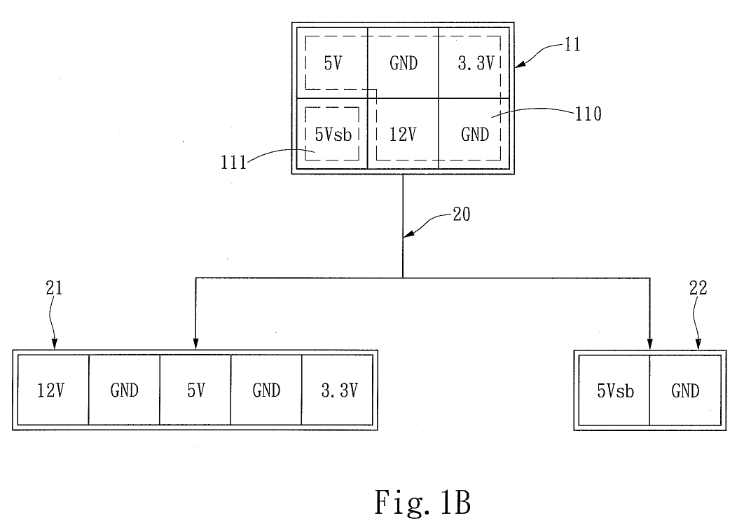

Please refer to FIGS. 1A and 1B for a first embodiment of a power supply having multiple sets of output power according to the invention. It is electrically connected to a computer host 50 to provide electric power required by an external electronic device 40. The power supply 10 is located on the computer host 50, and has a primary power system to transform AC power to DC power when the computer host 50 is in a power on condition, and a standby power system connecting to the AC power and transforming the AC power to the DC power in regular conditions when the computer host is shut down. The power supply 10 has a power output port 11 at one end exposed to an outer side. In the drawings the power output port 11 is exposed from one end of the power supply 10 located on the chassis of the computer host 50. It has a primary power terminal dock 110 connecting to the primary power system to output primary power and a standby power terminal dock 111 connecting to the standby power system to output standby power. In this embodiment the primary power terminal dock 110 and the standby power terminal dock 111 are defined respectively for firewire power terminals that have a relative high potential and a relative low potential of 12V, 5V, 5Vsb and 3.3V, and a GND ground power terminal. The standby power terminal dock 111 outputs power 5Vsb in the regular conditions. Through a transmission line 20 which has an adapter end 23 at one end electrically connected to the power output port 11 and other end forming at least a first coupling end 21 (defined as connection ports matching SATA specifications of 12V, GND, 5V, GND and 3.3V) and a second coupling end 22 (defined as connection ports matching USB specifications of 5Vsb and GND) connecting respectively to the primary power terminal dock 110 and the standby power terminal dock 111 to transform power to the same potential. Thus they can be linked to a corresponding computer equipment 30 (such as hard disk) and the external electronic device 40 (such as a mobile phone). As a result, when the computer host 50 is power on, the primary power and the standby power of the power supply 10 can be sent respectively to the computer equipment 30 and external electronic device 40. When the computer host 50 is shut down, the external electronic devices 40 still can get the standby power and is operable.

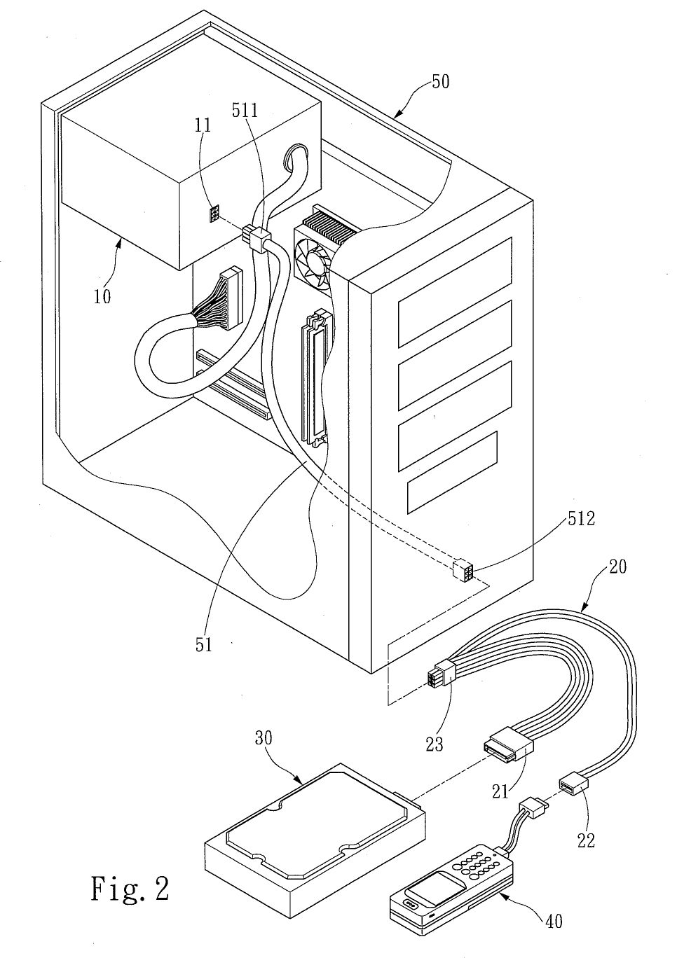

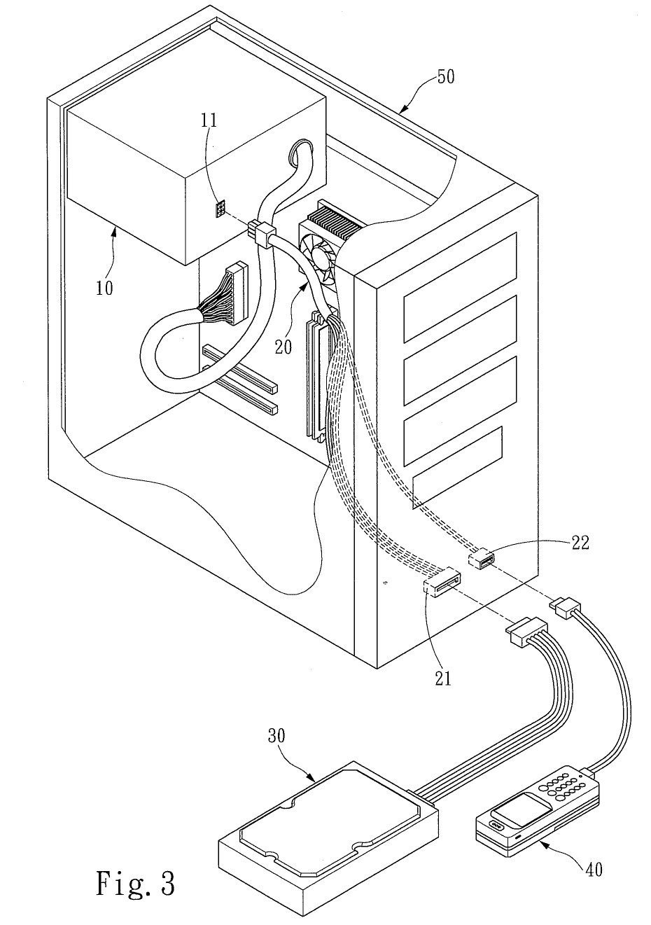

In this embodiment the computer equipment 30 is not limited to the hard disk, and may include optical disks, disk burners and the like. The external electronic device 40 may be a MP3 player, digital camera or console of a video game that can receive electric power while the computer host 50 is power on or shut down to be charged or operated. In addition, the power output port 11, aside from located at one end of the power supply 10 on the chassis of the computer host 50 and exposed, can also be located at one end of the power supply 10 held inside the computer host 50 as shown in FIG. 2. The power output port 11 and the transmission line 20 are bridged by a linking line 51 which has a coupling port 511 at one end coupling with the power output port 11 and an extension port 512 at other end coupling with the adapter end 23 of the transmission line 20 located on the chassis of the computer host 50. Referring to FIG. 3, the transmission line 20 coupling with the power output port 11 is held inside the computer host 50 with the first coupling end 21 and second coupling end 22 directly fastened to the chassis of the computer host 50 so that the computer equipment 30 and external electronic device 40 can be connected respectively and electrically to the first coupling end 21 and the second coupling end 22 to get electric power.

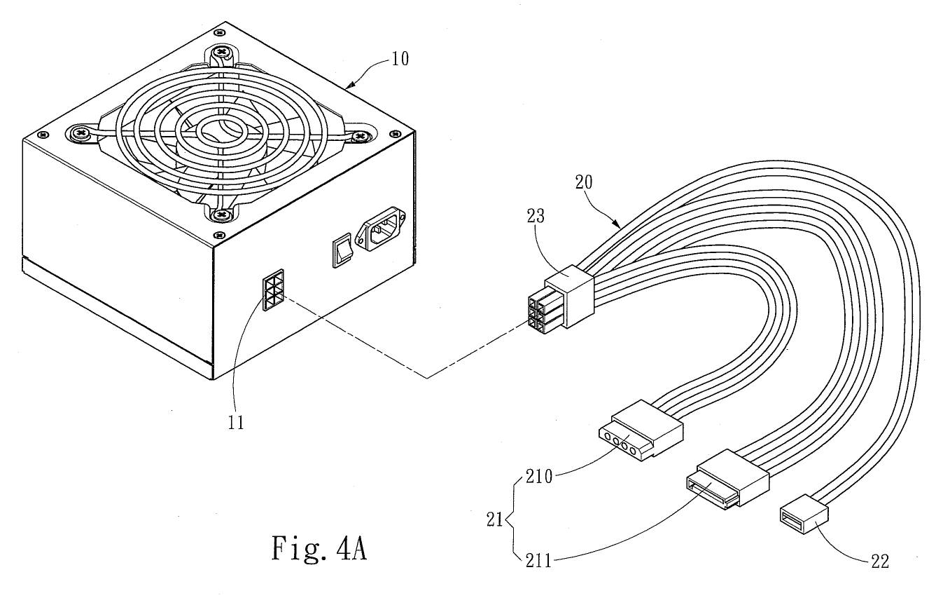

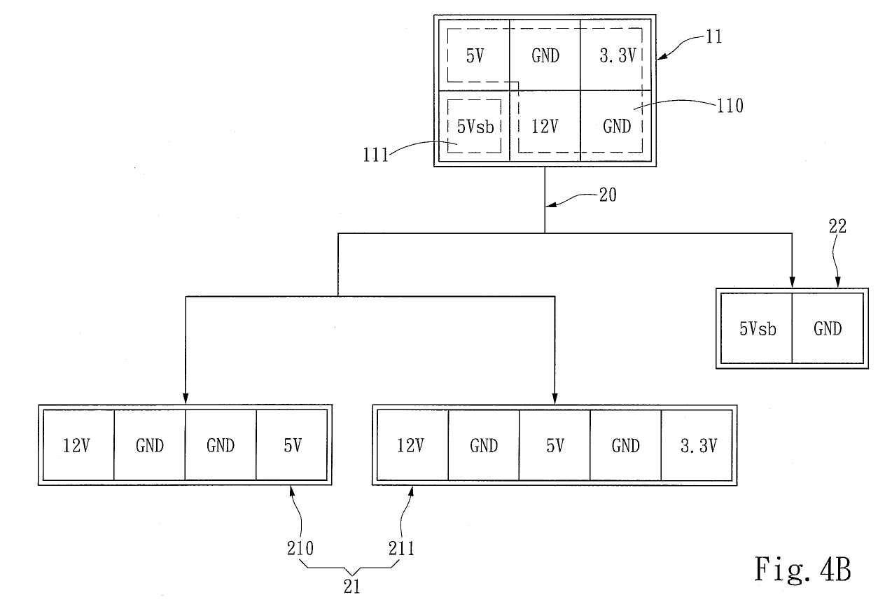

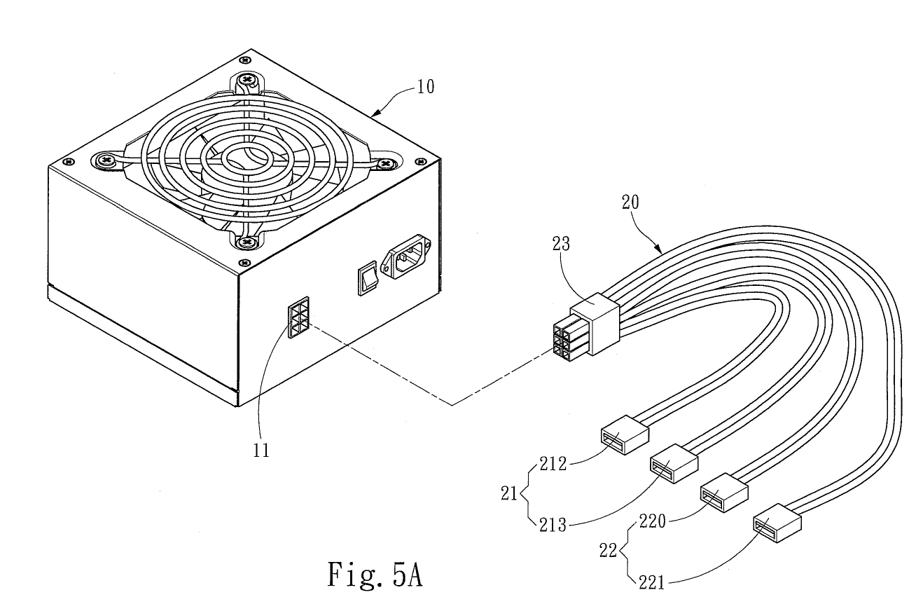

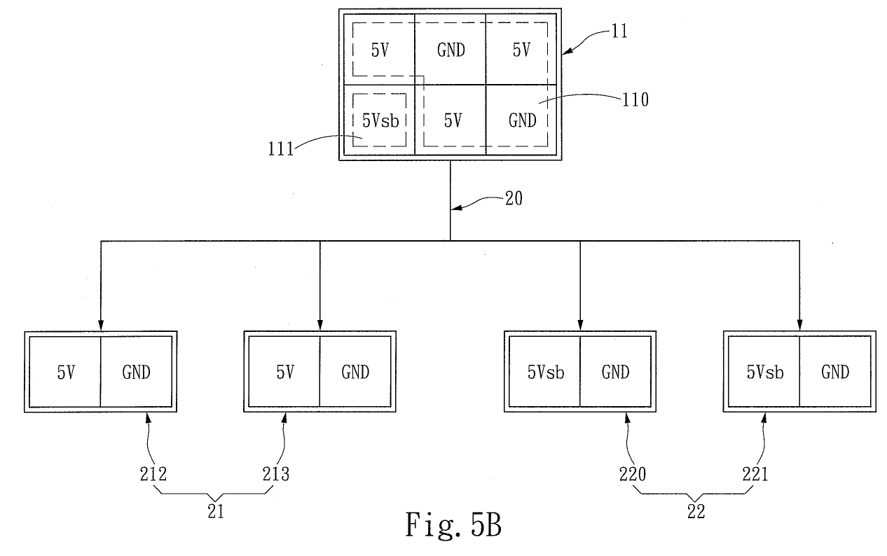

The first coupling end 21 and the second coupling end 22 of the transmission line 20 are not limited to single connection ports as depicted in the embodiments preciously discussed, and can include multiple connection ports. FIGS. 4A and 4B show another embodiment of the transmission line 20. It has the first coupling port 21 consisting of a first connection port 210 conforming to large 4P specifications for 12V, GND, GND, and 5V, and a second connection port 211 conforming to SATA specifications for 12V, GND, 5V, GND, and 3.3V. FIGS. 5A and 5B show yet another embodiment in which the firewire terminals of the primary power terminal dock 110 and the standby power terminal dock 111 are defined as potentials of 5V and 5Vsb. The first coupling end 21 of the transmission line 20 further has a third connection port 212 and a fourth connection port 213 conforming to USB specifications of 5V and GND to match the potential of the primary power terminal dock 110. Thus primary power can be supplied to the required computer equipment 30. The second coupling end 22 includes other connection ports 220 and 221 conforming to USB specifications of 5Vsb and GND. Thus whether the first coupling end 21 and second coupling end 22 are single connection ports or multiple connection ports, the external electronic device 40 connected to the second coupling end 22 can get electric power whether the computer host 50 is power on or shut down.

As a conclusion, the power supply 10 of the invention has the power output port 11 located outside that includes the primary power terminal dock 110 linking to the primary power system to output the primary power and the standby power terminal dock 111 linking to the standby power system to output the standby power, and the transmission line 20 to transmit the primary power from the primary power terminal dock 110 to the computer equipment 30 and the standby power from the standby power terminal dock 111 to the external electronic device 40. Thus the external electronic device 40 can get the standby power even the power supply 10 is shut down. It solves the problem of the conventional power supply that provides electric power only when it is power on. As a result, the invention can simplify power supply for the external electronic device 40.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A power supply having multiple sets of output power to provide electric power required by an external electronic device electrically connected to a computer host, comprising:
a power supply having a primary power system to transform AC power to DC power when the computer host is in a power on condition and a standby power system to link and transform the AC power to the DC power in regular conditions when the computer host is shut down;
a power output port which is located at one end of the power supply and exposed outside and has a primary power terminal dock linking to the primary power system to output primary power and a standby power terminal dock linking to the standby power system to output standby power; and
a transmission line which has an adapter end at one end electrically connected to the power output port and other end forming at least a first coupling end to output the primary power and a second coupling end to output the standby power.

2. The power supply of claim 1, wherein the primary power terminal dock and the standby power terminal dock include firewire power terminals and ground power terminals.

3. The power supply of claim 2, wherein the firewire power terminals include a first firewire power terminal of a relative high potential and a second firewire power terminal of a relative low potential.

4. The power supply of claim 2, wherein the firewire power terminals have a same potential.

5. The power supply of claim 1, wherein the power output port is located at the one end of the power supply on a chassis of the computer host and exposed outside.

6. The power supply of claim 1, wherein the power output port is located at the one end of the power supply on a chassis of the computer host and held inside the computer host.

7. The power supply of claim 6, wherein the power output port and the transmission line are bridged by a linking line which has a coupling port at one end connecting to the power output port and an extension port at other end located on a chassis of the computer host.

8. The power supply of claim 6, wherein the transmission line is located on the computer host, and the first coupling end and the second coupling end are located on a chassis of the computer host.

9. The power supply of claim 1, wherein the first coupling end is a single connection port.

10. The power supply of claim 1, wherein the first coupling end includes multiple connection ports.

11. The power supply of claim 1, wherein the second coupling end is a single connection port.

12. The power supply of claim 1, wherein the second coupling end includes multiple connection ports.
